(19) United States
(12) Patent Application Publication
(10) Pub. No.: US 2026/0166879 A1
(43) Pub. Date: Jun. 18, 2026

(54) IMAGE FORMING APPARATUS AND SET OF INK AND CLEANING LIQUID

(71) Applicant: Toshiyuki KOBASHI, Tokyo (JP)

(72) Inventor: Toshiyuki KOBASHI, Tokyo (JP)

(21) Appl. No.: 19/417,416

(22) Filed: Dec. 12, 2025

(30) Foreign Application Priority Data
Dec. 18, 2024 (JP) 2024-221982

(51) Int. Cl. B41J 2/14; B41J 2/165; C09D 11/322

(52) U.S. Cl. CPC B41J 2/1433; B41J 2/16502; B41J 2/16505; C09D 11/322; B41J 2202/03

(57) ABSTRACT

An image forming apparatus includes an ink that contains a pigment, a resin, a water-soluble organic solvent, and water, a cleaning liquid, and a head that includes a nozzle plate including a nozzle substrate including nozzle holes having a diameter of 18 to 30 μm to discharge the ink, and a nozzle surface with water repellent film thereon, wherein the ink has a surface tension of 26 to 40 mN and a contact angle of at least 66 degrees on the water repellent film.

### CROSS-REFERENCE TO RELATED APPLICATIONS

This patent application is based on and claims priority pursuant to 35 U.S.C. § 119 to Japanese Patent Application No. 2024-221982 filed on Dec. 18, 2024, in the Japan Patent Office, the entire disclosure of which is hereby incorporated by reference herein.

### BACKGROUND

### Technical Field

The present disclosure relates to an image forming apparatus and a set of an ink and a cleaning liquid.

### Description of the Related Art

Since inkjet printers are capable of readily and quietly printing color images with low running costs, they are now widely used at home to output digital information.

Pigment inks have been widely used in inkjet printing apparatuses due to their excellent water resistance and lightfastness.

Inkjet printing apparatuses using pigment inks have also come to be used for commercial printing applications such as high-speed continuous-feed printers, and for industrial printing applications such as printing on fabrics. To ensure proper ink fixing for these applications, various measures have been taken, such as incorporating resin into the ink.

On the other hand, pigment inks containing resin tend to adhere to the nozzle surface, making it increasingly difficult to ensure reliable ink discharge.

In response, methods have been developed to form a water repellent film on the nozzle surface to prevent ink from adhering near the periphery of the nozzle orifices, thereby improving ink droplet discharging stability.

As another approach, methods have been studied in which ink adhering to the discharging surface of the recording head is cleaned using a cleaning liquid.

### SUMMARY

The present disclosure described herein provides an image forming apparatus which includes an ink that contains a pigment, a resin, a water-soluble organic solvent, and water, a cleaning liquid, and a head that includes a nozzle plate including a nozzle substrate with nozzle holes having a diameter of 18 to 30 μm for discharging the ink, and a nozzle surface with water repellent film thereon, wherein the ink has a surface tension of 26 to 40 mN and a contact angle of at least 66 degrees on the water repellent film.

As another aspect of the present disclosure, a set is provided which includes an ink containing a pigment, a resin, a water-soluble organic solvent, and water, a cleaning liquid containing a silicone-based surfactant, and water, wherein the set is used in an image forming apparatus that includes a head including a nozzle plate including a nozzle substrate with nozzle holes having a diameter of 18 to 30 μm for discharging the ink, and a nozzle surface with a water repellent film containing a silicone material on the nozzle surface, wherein the cleaning liquid has a static contact angle on the water repellent film of at most 65 degrees, wherein the ink has a surface tension of 26 to 40 mN and a contact angle on the water repellent film of at least 66 degrees.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein:

FIG. 1 is a schematic diagram illustrating a perspective view of an example of the image forming apparatus;

FIG. 2 is a diagram illustrating a perspective view of an example of the tank of the image forming apparatus;

FIG. 3 is a diagram illustrating an exploded perspective view of the ink discharging head;

FIG. 4 is a diagram illustrating a cross sectional view of the ink discharging head along the direction (longitudinal direction of the liquid chamber) vertical to the nozzle arrangement direction of the head;

FIG. 5 is a diagram illustrating a cross section of the ink discharging head along the nozzle arrangement direction (latitudinal direction of the liquid chamber);

FIG. 6 is a diagram illustrating a plan view of a nozzle plate;

FIG. 7 is a diagram illustrating a cross sectional view of the nozzle plate;

FIG. 8 is a diagram illustrating an enlarged cross sectional view of a nozzle portion of the nozzle plate.

FIG. 9 is a schematic diagram illustrating an example of the cleaning device for an ink discharging head; and

FIGS. 10A, 10B, and 10C are schematic diagrams illustrating another example of the cleaning device for the ink discharging head.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, it a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

According to the present disclosure, an image forming apparatus is provided which maintains the reliability of ink discharging even when the water repellent film deteriorates and exhibits excellent recoverability from nozzle clogging.

The inventors of the present invention have found that repeated maintenance operations cause wear of the water repellent film, making the film more susceptible to wetting by ink, which leads to discharging defects such as ink droplet misdirection and ink dripping. Furthermore, it has been discovered that ink tends to adhere more strongly to worn water repellent film, resulting in similar discharging defects.

In particular, inks containing white pigments such as titanium oxide, which have larger particle sizes and a tendency to sediment compared to typical color inks, and high-solid-content inks containing at least 6 percent by mass of resin, are prone to discharging failures due to pigment and resin components solidified in the ink when the ink near the nozzle orifice dries.

Therefore, in order to maintain stable discharging, it is necessary to retain a meniscus even on a worn water repellent film, and to remove deposits adhered near the nozzle orifice using a cleaning liquid.

One method of retaining the meniscus is to increase the surface tension of the ink; however, in order to achieve sufficient color development on paper or fabric media, the ink must adequately spread on the media, and thus the surface tension has to be no greater than 40 mN/m.

Another method is to reduce the diameter of the nozzle orifice to facilitate meniscus retention. However, if the nozzle orifice diameter is too small, ink near the orifice is likely to thicken or solidify, making it difficult to recover from nozzle clogging. Therefore, the diameter has to be at least 18 μm.

Accordingly, in order to maintain these conditions and ensure discharging stability at the same time, it is suitable to maintain high wettability on the nozzle surface. It has been found that long-term stable discharging is achieved when the contact angle with respect to the water repellent film is at least 66 degrees.

The image forming apparatus of the present disclosure is described in detail below. The embodiments of the present disclosure are not limited to the following descriptions and can be changed within the scope of the present disclosure. In the ranges of (from) a figure A to figure B in the present specification, the figure A and the figure B are both inclusive as the lower limit and the upper limit.

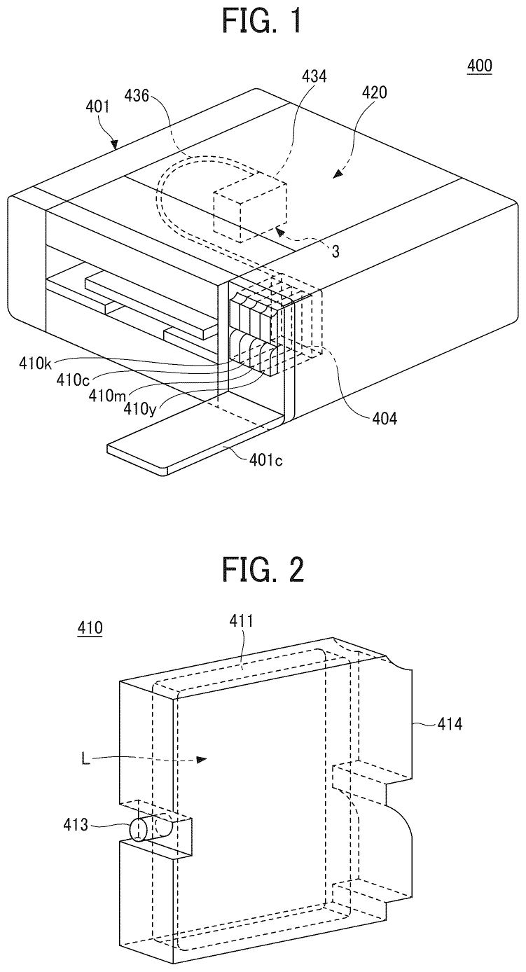

The recording (print) device is described using an example with reference to FIG. 1 and FIG. 2. FIG. 1 is a diagram illustrating a perspective view of a printing device. FIG. 2 is a diagram illustrating a perspective view of a tank.

### Image Forming Apparatus

### Printing Device and Printing Method

In the present disclosure, the printing device (recording device) and the printing method (recording method) respectively represent a device capable of discharging ink and liquids such as processing fluids to a printing medium and a method of printing utilizing such a device. The recording (printing) medium refers to an item to which ink or processing fluids can be temporarily or permanently attached.

The recording (printing) device may furthermore optionally include a device relating to feeding, conveying, and ejecting a printing medium and other devices referred to as a pre-processing device and a post-processing device in addition to the head portion for discharging an ink.

The printing device and the printing method may further optionally include a heater for use in the heating process and a drier for use in the drying process. For example, the heating device and the drying device include devices including heating and drying the print surface of a printing medium and the opposite surface thereof. The heating device and the drying device are not particularly limited. For example, a fan heater and an infra-red heater can be used. Heating and drying can be conducted before, in the middle of, or after printing.

In addition, the printing device and the printing method are not limited to those producing meaningful visible images such as text and figures with ink. Apparatuses and devices for creating patterns like geometric design and 3D images are included.

In addition, the printing device includes both a serial type device with a movable liquid discharging head and a line type device with a fixed liquid discharging head, unless otherwise specified.

Furthermore, in addition to the desktop type, this printing device includes a device capable of printing images on a wide printing medium having, for example, A0 size, and a continuous printer capable of using continuous paper rolled up in a roll-like form as a printing medium.

An image forming apparatus 400 as an embodiment of the printing device is a serial image forming apparatus. The image forming apparatus 400 includes a mechanical unit 420 inside an exterior 401. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414 and L represents liquid contained in the ink accommodating unit 411. The tank 410 is used as an ink cartridge of each color. Each color ink is not limited to black (K), cyan (C), magenta (M), and yellow (Y) but to other color ink such as white (W) and metallic ink. Each tank 410 and each ink accommodating unit 411 are not limited in the same manner as those.

A cartridge holder 404 is disposed on the rear side of the opening appearing when a cover 401c is opened. The tank 410 is detachably attached to the cartridge holder 404. This configuration enables each ink discharging outlet 413 of the tank 410 to communicate with a discharge head 434 for each color via a supplying tube 436 for each color so that the ink can be discharged from the discharge head 434 to a printing medium. In addition, the tank 410 for each color or each ink accommodating unit 411 may be filled with a pre-processing fluid or a post-processing fluid instead of ink so that the discharging head 434 can discharge them to a printing medium.

Notably, the ink is applicable not only to the inkjet printing but can be widely applied in other methods.

Specific examples of such methods other than inkjetting include, but are not limited to, blade coating methods, gravure coating methods, bar coating methods, roll coating methods, dip coating methods, curtain coating methods, slide coating methods, die coating methods, and spray coating methods.

This printing device may include not only a portion for discharging ink but also a device referred to as a pre-processing device and a post-processing device.

As one example of the pre-processing device and the post-processing device, like the ink of black (K), cyan (C), magenta (M), and yellow (Y) ink, the pre-processing device and the post-processing device further include a liquid accommodating unit including a pre-processing liquid or a post-processing liquid and a liquid discharging head. Thus, there is a way of discharging a pre-processing liquid or a post-processing liquid by an inkjet printing method.

Alternatively, the pre-processing device and the post-processing device possibly employ a blade coating method, a roll coating method, or a spray coating method other than the inkjet printing method.

Also, recording (printing) media, media, and printed matter in the present disclosure have the same meaning. Terms such as image forming, recording, printing, and print used in the present disclosure represent the same meaning.

### Head (Ink Discharging Head)

The head (ink discharging head) for use in the image forming apparatus of the present disclosure is described next.

The ink discharging head has a nozzle plate and other optional members.

### Nozzle Plate

The nozzle plate includes a nozzle substrate and an ink repellent film (i.e., water repellent film) on the nozzle substrate.

### Nozzle Substrate

The nozzle substrate has nozzle orifices, whose number, shape, size, material, and structure are not particularly limited and can be suitably selected according to a particular application.

The nozzle substrate has an ink discharging surface and a liquid chamber bonding surface on the opposite side to the ink discharging surface. The ink is discharged from the ink discharging surface through the orifices.

The cross section of the nozzle substrate may be a flat plate-like shape or plate-like shape.

The nozzle substrate is allowed to take any size and can be suitably according to the size of the nozzle plate.

There is no particular limitation on the material for the nozzle substrate and it can be suitably according to a particular application. Specific examples include, but are not limited to, Al, Bi, Cr, InSn, ITO, Nb, Nb₂O₅, NiCr, Si, SiO₂, Sn, Ta₂O₅, Ti, W, ZAO(ZnO+Al₂O₃), and Zn. These can be used alone or in combination. Of these, stainless steel is preferable to prevent rust.

There is no specific limitation on stainless steel and it can be suitably selected according to a particular application.

Specific examples include, but are not limited to, austenite-based stainless steel, ferrite-based stainless steel, martensite-based stainless steel, and precipitation curing-based stainless steel. These can be used alone or in combination.

At least the ink-discharging surface of the nozzle substrate may be subjected to oxygen plasma treatment for introducing a hydroxyl group, which enhances the attachability between the ink repellent film and the nozzle substrate.

### Nozzle Orifice

The nozzle orifice is not particularly limited with respect to the number, arrangement, spacing, and the shape, size, and cross-sectional shape of the aperture and it can be suitably selected according to a particular application.

The arrangement of the nozzles is not particularly limited and can be suitably according to a particular. For example, nozzles can be equally spaced therebetween along the length direction of the nozzle substrate.

The nozzle arrangement depends on the type of ink discharged. It is preferably one or more lines of orifices and more preferably one to four lines.

The number of the nozzle orifices per rank is not particularly limited and can be suitably select depending on a particular application. For example, the number is preferably from 10 to 10,000 and more preferably from 50 to 500.

The pitch P, the minimum distance between the centers of adjacent nozzle orifices, is not particularly limited and can be suitably according to a particular application. It is preferably from 21 to 169 μm.

The shape of the nozzle aperture mentioned above is not particularly limited and can be suitably selected according to a particular application. Circular, elliptical, and square shapes are suitable. Among these, a circular shape is preferable to discharge ink droplets.

The opening size of the nozzle orifice is between 18 μm and 30 μm in diameter, and more preferably between 18 μm and 24 μm. This is because a diameter of at least 18 μm is preferable from the viewpoint of recoverability from nozzle clogging, and a diameter of at most 30 μm is suitable to maintain a sufficient meniscus even during long-term use.

In cases where the shape of the nozzle orifice is not circular, the nozzle orifice diameter can be determined by drawing a circumscribed circle corresponding to the shape of the nozzle orifice and using the diameter of the circumscribed circle.

### Ink Repellent Film

The ink repellent film is formed on the surface on the ink discharging side of the nozzle substrate, which faces a print target. The static contact angle of the ink on the surface facing a print target is at least 66 degrees.

The planar shape of the nozzle substrate is not particularly limited and can be suitably selected according to a particular application. Examples include, but are not limited to, a rectangle, a square, a rhombus, a circle, and an ellipse.

The ink repellent film is formed on the nozzle surface on the ink discharging side of the nozzle substrate, which has multiple recesses, and its shape, structure, material, thickness are not particularly limited and are appropriately selected according to the intended purpose.

There is no particular limitation on the material of the ink repellent film and it is suitably selected according to a particular application. For example, silicone resin and fluororesin are suitable in terms of repellency to the ink.

### Silicone Resin

Silicone resin has a siloxane bonding of Si and O as a backbone. It can be procured in a form such as oil, resin, and elastomer. Silicone resin includes properties such as heat resistance, releasability, defoaming property, and adherence in addition to ink repellency. Silicone resin has types depending on how it cures: it cures at room temperature or by heating or ultraviolet irradiation. The type can be selected according to a method of manufacturing and usage.

A repellent film containing the silicone resin mentioned above can be formed on the nozzle surface by a method such as vapor deposition of liquid silicone resin, plasmapolymerization of silicone oil, or coating such as spin coating, dipping, and spray coating, and electrodeposition.

Aside from electrodeposition, the ink repellent layer containing silicone resin can be formed only on the surface of the nozzle plate by masking the nozzle orifices and the back surface of the nozzle plate with a photoresist or water-soluble resin, followed by peeling and removing the resist. It is of note that a strong alkali stripping agent damages an ink repellent layer.

The thickness of the ink repellent film containing the silicone resin is preferably from 0.1 to 5.0 μm and more preferably from 0.1 to 1.0 μm.

### Fluororesin

Preferable examples of the fluororesin include, but are not limited to, perfluoro polyether compounds, fluorinated polyacrylate polymers, and polymers with a fluorinated heterocyclic structure in the main chain.

Since the ink repellent film contains a fluorinated polyacrylate polymer or a polymer having a fluorinated heterocyclic structure in its main chain, it significantly reduces the surface free energy. This is preferable because it allows the surface to remain resistant to wetting even when the low-surface-tension ink of the present disclosure is employed.

The proportion of fluorine in the fluorinated polyacrylate is preferably at least 10 percent by mass, more preferably at least 25 percent by mass, and furthermore preferably at least 50 percent by mass in terms of ink repellency (contact angle).

The fluorinated polyacrylate polymer can be either synthesized or procured commercially.

Specific examples of the commercially available products include, but are not limited to, krytoxFSL (manufactured by E.I. du Pont de Nemours and Company), krytoxFSH (manufactured by E.I. du Pont de Nemours and Company), FomblinZ (manufactured by Solvay Solexis), FLUOROLINKS10 (manufactured by Solvay Solexis), Optool DSX (manufactured by DAIKIN INDUSTRIES, LTD.), FLUOROLINKC10 (manufactured by Solvay Solexis), Morescophospharol A20H (manufactured by Matsumura Oil Co., Ltd.), Morescophospharol ADOH (manufactured by Matsumura Oil Co., Ltd.), Morescophospharol DDOH (manufactured by Matsumura Oil Co., Ltd.), Fluorosurf FG5010 (manufactured by Fluoro Technology), Fluorosurf FG5020 (manufactured by Fluoro Technology), and Fluorosurf FG5070 (manufactured by Fluoro Technology), CYTOP CTX-105 (manufactured by AGC Inc.), CYTOP CTX-805 (manufactured by AGC Inc.), TEFLON® AF-1600 and AF2400 (manufactured by DuPont de Nemours, Inc.).

The ink repellent film is formed of a compound film containing the fluorinated acrylate ester polymer backbone in the molecule. An inorganic oxide layer can be provided between the nozzle substrate and the ink repellent film in order to improve cohesiveness by allowing a large number of hydroxyl groups present as bonding points with the compound containing a fluorinated acrylate ester polymer backbone in the molecule.

Specific examples of the material of the inorganic oxide layer include, but are not limited to, SiO₂ and TiO₂.

The average thickness of the inorganic oxide layer is preferably from 0.001 to 0.2 μm and more preferably from 0.01 to 0.1 μm.

Examples of the method of forming an ink repellent film using a compound containing a fluorinated polyacrylate backbone in the molecule include, but are not limited to, dipping, printing, and vacuum deposition by, for example, spin coating, roll coating, and dipping using a fluorinated solvent.

Specific examples of the fluorinated solvent include, but are not limited to, Novec (manufactured by 3M Company), Vertrel (manufactured by DuPont de Nemours, Inc.), Galden (manufactured by Solvay Solexis), Afroude (fluorine-based solvent manufactured by AGC Inc.), and Fluorinert FC-75 (liquid containing perfluoro (2-butyltetrahydrofuran, manufactured by 3M Company).

### Other Members

The other members are not particularly limited and can be suitably selected according to a particular application. Examples include, but are not limited to, a pressurizing chamber and a stimulus generating device.

### Pressurizing Chamber

The pressurizing chamber is disposed corresponding to each of the nozzle orifices provided to the nozzle plate. The pressurizing chamber is individual flow paths communicating with the nozzle orifices and also referred to as ink flow path, pressurizing liquid chamber, pressure chamber, discharging chamber, and liquid chamber.

### Stimulus Generating Device

The ink discharging head includes a device that generates a stimulus to be applied to an ink.

The stimulus applied by a stimulus generating device is not particularly limited and can be suitably selected according to a particular application. Examples include, but are not limited to, heat (temperature), pressure, vibration, and light. These can be used alone or in combination. Of these stimuli, heat and pressure are preferable.

Examples of the stimulus generating device include, but are not limited to, a heater, a pressurizing device, a piezoelectric element, a vibrator, an ultrasonic oscillator, and light.

Specific examples include, but are not limited to a piezoelectric actuator such as a piezoelectric element, a thermal actuator utilizing phase change by boiled ink film with an electric heat conversion element such as a heat generating resistance, a shape-memory alloy actuator utilizing metal phase change utilizing temperature changes, and an electrostatically actuated actuator.

In the case that the stimulus is heat, thermal energy is applied to the ink in an ink discharging head in response to recording signals with a device such as a thermal head.

Bubbles are generated in the ink upon the application of thermal energy. As the pressure of the bubbles increases, the ink discharging head discharges droplets of the ink through the nozzle orifices.

In the case that the stimulus is pressure, for example, a voltage is applied to the piezoelectric element attached at the position referred to as a pressure chamber in the ink flow path in an ink discharging head, thus bending the piezoelectric element. Owing to this bend, the pressurizing chamber shrinks, so that the ink is discharged from the nozzle orifices of the ink discharging head.

When pressure is utilized as the stimulus, the piezoelectric method is preferable in which the ink is jetted by applying a voltage to a piezoelectric element.

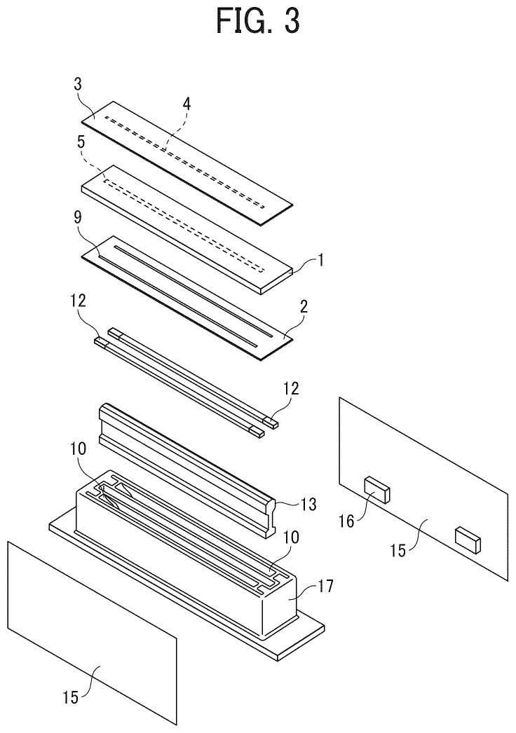

Next, an example of the inkjet discharging head for use in the present disclosure will be described with reference to FIG. 3 to FIG. 8.

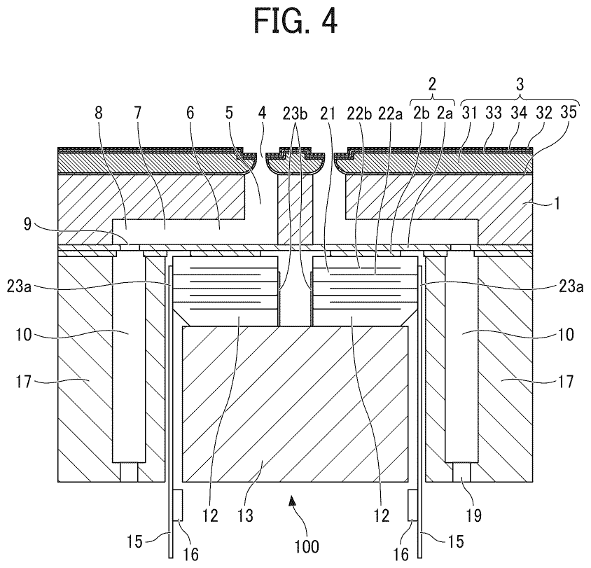

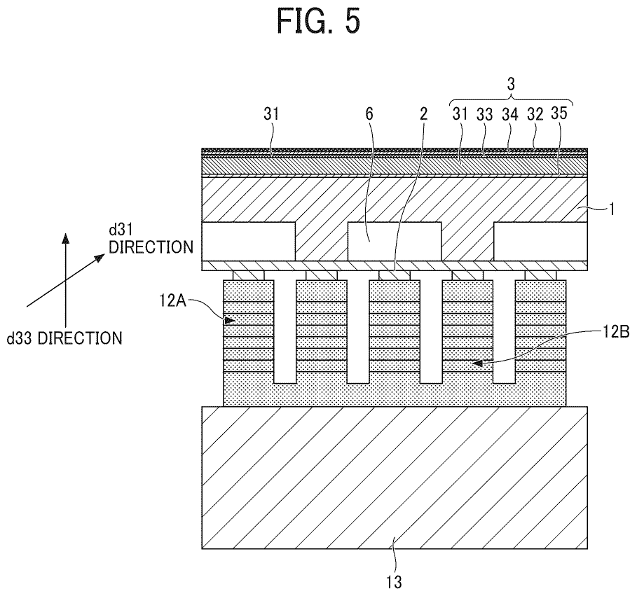

FIG. 3 is a diagram illustrating an exploded perspective view of an ink discharging head, FIG. 4 is a diagram illustrating a cross section along the direction (longitudinal direction of liquid chamber) perpendicular to the nozzle arrangement direction of the ink discharging head, and FIG. 5 is a diagram illustrating a cross section along the direction (latitudinal direction of liquid chamber) of the nozzle arrangement of the ink discharging head.

The ink discharging head includes a flow path plate (also referred to as liquid chamber substrate, flow path member) 1, a diaphragm 2 jointed onto the bottom surface of the flow path plate 1, and a nozzle plate 3 as the nozzle forming member joined with the top surface of the flow path plate 1. The static angle of the ink on the surface side of the nozzle plate 3 facing the print target is at least 66 degrees.

The ink discharging head is formed of liquid chambers 6 serving as individual paths communicating with nozzle orifices 4 to discharge droplets (droplets of liquid) via a nozzle communicating path 5, a fluid resistance 7 doubled as a supplying path through which the ink is supplied to the individual liquid chamber 6, and a communicating unit 8 communicating with the individual liquid chambers 6 via the fluid resistance 7. The ink is supplied to the communicating unit 8 from a common liquid chamber 10 formed on a frame member 17 via a supply opening 19 formed on the diaphragm 2. The liquid chambers 6 are also referred to as pressurizing liquid chamber, pressure chamber, or flow path.

Openings such as the nozzle communication path 5, the liquid chambers 6, and the fluid resistance 7 are formed on the flow path plate 1 by etching a silicone substrate. The flow path plate 1 can also be formed by, for example, etching a SUS substrate using an acidic etching solution or mechanical processing such as punching (pressing).

The diaphragm 2 includes a vibration region (diaphragm portion) 2a forming the wall of the corresponding liquid chamber 6. The diaphragm 2 has an island convex portion 2b on the outer surface if the vibration region 2a, which is the opposite to the liquid chamber 6. The island convex portion 2b deforms the vibration region 2a to join a piezoelectric element 12 (i.e., actuator, pressure generator) of a laminate type to generate energy for discharging droplets and upper surfaces (joined surfaces) of each of piezoelectric element columns 12A and 12B for the piezoelectric element 12. The lower end surface of the piezoelectric element 12 is joined to a base member 13.

The piezoelectric element 12 is formed by alternately stacking a piezoelectric layer 21 such as PZT and inside electrodes 22A and 22B. The inside electrodes 22a and 22b are drawn out to the side which is substantially perpendicular to the diaphragm 2 of the piezoelectric element 12. The piezoelectric element 12 is connected to side surface electrodes (exterior electrodes) 23a and 23b formed on the side substantially perpendicular to the diaphragm 2 of the piezoelectric element 12 and applies a voltage to the side surface electrodes 23a and 23b to cause displacement along the stacking direction.

The piezoelectric element 12 is subjected to groove processing by half cut dicing to form a required number of piezoelectric element columns 12A and 12B for one piezoelectric element member.

Although the piezoelectric element columns 12A and 12B of the piezoelectric element 12 are identical, they are distinguished in that a drive waveform is applied to column 12A to drive it, whereas no drive waveform is applied to the piezoelectric element column 12B, which serves as a simple support.

This configuration can be applied to a bi-pitch configuration alternatively using the piezoelectric element column 12A for drive and the piezoelectric element column 12B for support or a normal pitch configuration using all the piezoelectric element columns as the piezoelectric element column 12A.

The piezoelectric element columns 12A and 12B of the piezoelectric element 12 are arranged in two rows of the driving elements (rows of the piezoelectric element columns 12A for drive) in which a plurality of driving piezoelectric element columns 12A for drive are arranged as drive elements on the base member 13.

The piezoelectric direction of the piezoelectric element 12 of a laminate type applies pressure to the ink in the liquid chamber 6 utilizing the displacement along the d33 direction (lamination direction of the piezoelectric element material layer). Also, the piezoelectric direction of the piezoelectric element 12 of a laminate type applies pressure to the ink in the liquid chamber 6 utilizing the displacement along the d31 direction (the surface direction of the piezoelectric material layer: direction perpendicular to electric field).

The material of the piezoelectric element is not particularly limited. Examples include, but are not limited to, electromechanical conversion elements such as ferroelectric materials including BaTiO₃, PbTiO₃, and (NaK)NbO₃ used as generally used piezoelectric element materials.

Further, although the piezoelectric element of a laminate type is used, a single-plate piezoelectric element may be used.

As the single-plate piezoelectric element, a cut piezoelectric element, a thick-film element obtained by screen printing followed by sintering, or a thin-film element formed by sputtering, vapor deposition, or a sol-gel method can be used.

Moreover, the piezoelectric elements 12 of a laminate type provided on one base member 13 may have a single row-structure or a multiple-row structure.

An FPC 15 as a wiring device is directly connected to the external electrode 23a of each piezoelectric element column 12A of the piezoelectric element 12 with solder to provide drive signals. A drive circuit (driver IC) 16 is mounted onto the FPC 15 to selectively apply a drive waveform to the piezoelectric element column 12A for driving of the piezoelectric element 12.

The external electrodes 23b of all the piezoelectric element columns 12A for driving are electrically connected and similarly connected to the common wiring of the FPC 15 by a solder member.

Further, the output terminal portion jointed to the piezoelectric element 12 of the FPC 15 is plated with solder, thereby enabling the solder joint. It is also possible to solder plate not on the FPC but on the piezoelectric element 12.

In addition, as for the joining method, it is possible to utilize jointing by an anisotropic conductive film or wire bonding in addition to the soldering

The nozzle plate 3 has an ink repellent film (or water repellent film) 32 formed on a liquid droplet discharging side (surface along the discharging direction, discharging surface or the opposite surface relative to the liquid chamber 6, nozzle forming surface) of the nozzle substrate 31 on which holes constituting the nozzle orifices 4 having a diameter of from 18 to 30 μm corresponding to each liquid chamber 6.

The nozzle orifice diameter can be shaped to a desired opening size by methods such as electroforming, punching a plate with a punch having a nozzle shape, or using an excimer laser.

In addition, the frame member 17 formed of an epoxy resin or polyphenylene sulfide by injection molding is jointed on the outer peripheral side of a piezoelectric actuator unit 100 including the piezoelectric element 12 on which the FPC 15 is mounted (connected) and the base member 13.

The frame member 17 forms the common liquid chamber 10 and a supply opening 19 to supply ink to the common liquid chamber opening 10 from outside. This supply opening 19 is connected to an ink supply source such as a sub-tank and an ink container.

The operation in which the ink discharging head discharges ink from the nozzle orifices 4 (pull-push striking operation) will be specifically described.

In the liquid discharging head having such a configuration, the piezoelectric element column 12A for driving shrinks by lowering the voltage applied to the piezoelectric element column 12A from the reference voltage. The vibration region 2a of the diaphragm 2 is lowered, thereby inflating the volume of the liquid chamber 6 so that the ink flows into the liquid chamber 6. Thereafter, the voltage to be applied to the piezoelectric element column 12A is raised to elongate the piezoelectric element column 12A along the stacking direction.

The diaphragm 2 is deformed along the nozzle orifices 4 to shrink the volume of the liquid chamber 6, thereby applying pressure to the ink in the liquid chamber 6 so that the liquid droplet of the ink is discharged (jetted) from the nozzle orifices 4.

Thereafter, when the voltage applied to the piezoelectric element column 12A is returned to the reference voltage, the diaphragm 2 is back to the initial position so that the liquid chamber 6 inflates, generating a negative pressure. At this time, the liquid chamber 6 is filled with the ink from the common liquid chamber 10.

After the vibration of the meniscus at the nozzle orifices 4 decays and becomes stable, the system starts operations to discharge the next droplet.

The driving method of the ink discharging head is not limited to the above example (pull-push striking), and it is also possible to perform pull striking or push striking depending on how the drive waveform is applied.

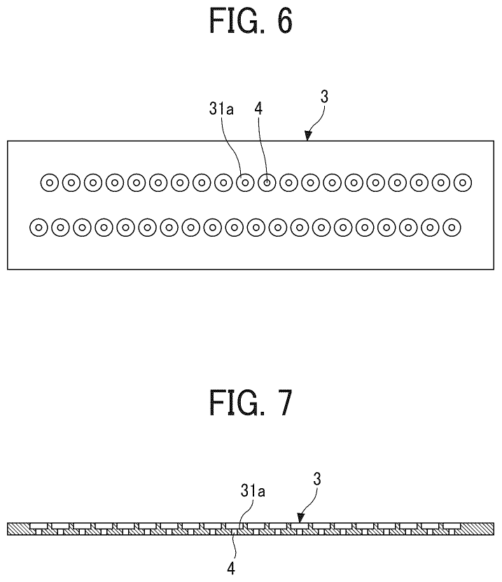

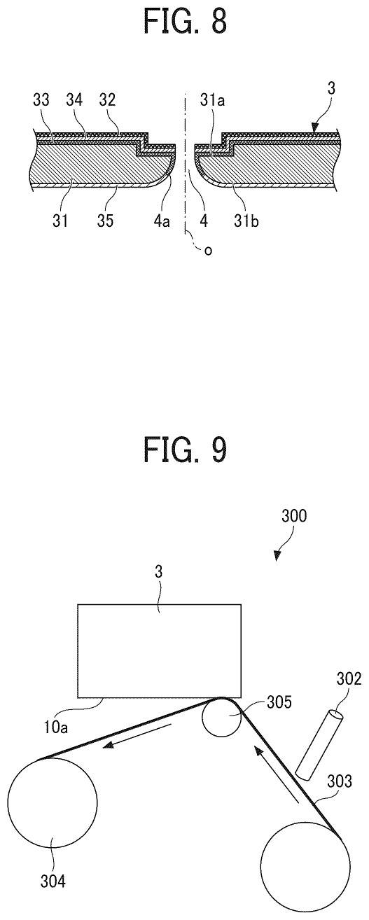

The nozzle plate 3 in the inkjet printing device of the present disclosure is described with reference to FIG. 6 to FIG. 8. FIG. 6 is a diagram illustrating a planar view of the nozzle plate 3, FIG. 7 is a diagram illustrating a cross section thereof, and FIG. 8 is a diagram illustrating an enlarged cross section of a single nozzle portion.

The nozzle plate 3 is formed, for example, by sequentially depositing, on the discharge surface 31a of a nozzle substrate 31 made of an Ni metal plate, a Ti layer 33 as a base layer, an SiO₂ film 34, and a perfluoropolyether film having an alkoxysilane group in its molecule (this film is referred to as a “water-repellent film”) 32.

The ink has a receding contact angle of at least 66 degrees on this surface, which excludes the nozzle holes of the nozzle plate 3 and faces the recording medium.

In the vicinity of the exit of the inner wall surface 4a of the nozzle orifices 4, the underlayer (Ti layer) 33 is continuously formed from the discharging surface on the SiO₂ film 35 formed on the liquid chamber surface 31b of the nozzle substrate 31. The underlayer (Ti layer) 33 is exposed to the outermost surface.

The nozzle substrate 31 can be formed of Ni metal plate but is not limited thereto.

The water repellent film 32 of the nozzle plate 3 is formed by vapor deposition and a vapor-deposited film for forming the water repellent film 32 is not formed near the exit of the inner wall surface of the nozzle orifices 4.

This makes it possible for the nozzle plate 3 to stably discharge droplets without causing discharging failure or impairing liquid filling property.

### Ink

The organic solvent, water, coloring material, resin, and additive for use in the ink are described below.

### Organic Solvent

There is no specific limitation on the organic solvent for use in the present disclosure. For example, a water-soluble organic solvent can be used. It includes, but is not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-buthoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent with a boiling point of at most 250 degrees Celsius, which serves as a humectant that dries quickly.

Polyol compounds having at least 8 carbon atoms and glycol ether compounds are also suitable.

Specific examples of the polyol compounds containing at least 8 carbon atoms include, but are not limited to, 2-ethyl-1,3-hexanediol and 2,2,4-trimethyl-1,3-pentanediol.

Specific examples of glycol ether compounds include, but are not limited to, ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, triethylene glycol monobutyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether, and other glycol ethers and polyhydric alcohol alkyl ethers; and polyhydric alcohol aryl ethers such as ethylene glycol monophenyl ether and ethylene glycol monobenzyl ether.

A polyol compound having at least 8 carbon atoms and a glycol ether compound enhance permeability of ink for paper used as a recording medium.

The proportion of the organic solvent in the ink has no particular limitation and can be suitably selected according to a particular application.

The proportion in the entire of the ink is preferably from 10 to 60 percent by mass and more preferably from 20 to 60 percent by mass to enhance drying and discharging reliability of the ink.

### Water

The proportion of water in the ink is not particularly limited and can be suitably selected according to a particular application. It is preferably from 10 to 90 percent by mass and more preferably from 20 to 60 percent by mass to quickly dry the ink and stably discharge it.

### Coloring Material

The coloring material has no particular limitation and includes such materials as a pigment and a dye.

The pigment includes an inorganic pigment or organic pigment. These can be used alone or in combination. Mixed crystal can also be used as the coloring material.

Examples of the pigments include, but are not limited to, black pigments, yellow pigments, magenta pigments, cyan pigments, white pigments, green pigments, orange pigments, and gloss or metallic pigments of gold, silver, and others.

Specific examples of the inorganic pigments include, but are not limited to, titanium oxide, iron oxide, calcium oxide, barium sulfate, aluminum hydroxide, barium yellow, cadmium red, and chrome yellow. In addition, carbon black that is manufactured by, for example, a known method such as a contact method, a furnace method, and a thermal method can be used.

Specific examples of the organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments with high affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, and iron (C.I. Pigment Black 11), and organic pigments such as aniline black (C.I. Pigment Black 1).

Specific examples of materials for white color include, but are not limited to, titanium oxide, iron oxide, calcium oxide, barium sulfate, and aluminum hydroxide.

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2 {Permanent Red 2B (Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in ink is preferably from 0.1 to 15 percent by mass and more preferably from 1 to 10 percent by mass to enhance the image density, fixability, and discharging stability.

Pigment dispersion ink is obtained by, for example, preparing a self-dispersible pigment by introducing a hydrophilic functional group into a pigment, coating the surface of a pigment with a resin followed by dispersion, or using a dispersant for dispersing a pigment.

One such method of preparing a self-dispersible pigment by introducing a hydrophilic functional group into a pigment is to add a functional group such as a sulfone group and carboxyl group to a pigment (e.g., carbon) to disperse the pigment in water.

One such method of dispersing a pigment by coating the surface of the pigment with resin is to encapsulate pigment particles in microcapsules for dispersion in water. A pigment whose surface is coated with resin and dispersed can be referred to as a resin-coated pigment. When dispersing resin-coated pigments, it is not necessary that all pigments added to the ink be completely coated with resin. Pigments that are partially or entirely uncoated may also be dispersed in the ink, provided they do not have an adverse impact.

One such method of using a dispersant for dispersing a pigment is to use a known dispersant of a small or large molecular weight, typically a surfactant.

As the dispersant, an anionic surfactant, a cationic surfactant, a nonionic surfactant, an amphoteric surfactant, or others can be suitably selected according to the pigment.

Also, a nonionic surfactant, Pionin RT-100, available from TAKEMOTO OIL & FAT CO., LTD. and a formalin condensate of naphthalene sodium sulfonate are suitable as the dispersant. Those can be used alone or in combination.

### Pigment Dispersion

Ink can be obtained by mixing a pigment with materials such as water and an organic solvent. It is also possible to mix a pigment with water, a dispersant, and other substances to prepare a pigment dispersion and thereafter mix the pigment dispersion with materials such as water and an organic solvent to manufacture ink.

The particle size of this pigment dispersion is adjusted by mixing or dispersing with water, a pigment, a pigment dispersant, and other optional components. It is good to use a dispersing device for dispersion.

The particle diameter of the pigment in the pigment dispersion is not particularly limited. For example, when the median diameter D50 (50 percent cumulative frequency) preferably from 20 to 500 nm and more preferably from 50 to 350 nm, dispersion stability of the pigment is enhanced and discharging stability and the image quality such as image density are also improved. The particle diameter of a pigment is measurable using a particle size analyzer (Nanotrac WaveII-UT151, available from MicrotracBEL Corp).

The proportion of the pigment in the pigment dispersion is not particularly limited and can be suitably selected according to a particular application. It is preferably from 0.1 to 50 percent by mass and more preferably from 0.1 to 30 percent by mass to achieve good discharging stability and high image density.

It is preferable that the pigment dispersion be filtered with an instrument such as filter and a centrifuge to remove coarse particles followed by deaerating.

### Resin

There is no specific limitation on the type of the resin contained in the ink, which can be suitably according to a particular application.

Specific examples thereof include, but are not limited to, urethane resins, polyester resins, acrylic-based resins, vinyl acetate-based resins, styrene-based resins, butadiene-based resins, styrene-butadiene-based resins, vinyl chloride-based resins, acrylic styrene-based resins, and acrylic silicone-based resins.

In particular, using resin particles made from these resins is preferable. It is possible to obtain an ink by mixing a resin emulsion in which such resin particles are dispersed in water as a dispersion medium with materials such as a coloring material and an organic solvent. The resin particle can be synthesized or procured. These resins can be used alone or two or more types of the resin particles.

There is no specific limitation on the volume average particle diameter of the resin particles and it can be suitably according to a particular application. The volume average particle diameter is preferably from 10 to 1,000 nm, more preferably from 10 to 200 nm, and furthermore preferably from 10 to 100 nm to achieve good image hardness.

The volume average particle diameter is measurable using a device such as a particle size analyzer (Nanotrac WaveII-UT151, available from MicrotracMRB Corp.).

The proportion of the resin is not particularly limited and can be suitably selected according to a particular application. It is preferably from 1 to 30 percent by mass and more preferably from 6 to 20 percent by mass to the entire ink to ensure fixability and storage stability of the ink.

The glass transition temperature of the resin is not particularly limited and can be suitably according to a particular application. It is preferably 0 degrees Celsius or lower. The inclusion of at least one type of resin particle having a glass transition temperature of 0 degrees Celsius or lower enhances the film forming of ink on a substrate, resulting in improvement of the abrasion resistance.

The glass transition temperature of the resin particle is measurable by a method such as differential scanning calorimetry (DSC) and differential thermal analysis.

The particle diameter of the solid portion in an ink has no particular limitation and can be suitably selected according to a particular application. The maximum frequency of the particle diameter of the solid portion in the ink is preferably from 20 to 1000 nm, more preferably from 20 to 500 nm, and even more preferably from 50 to 350 nm in the maximum number conversion to enhance discharging stability and image quality such as image density. The solid content includes particles such as resin particles and pigment particles. The particle diameter is measurable using a particle size analyzer (Nanotrac WaveII-UT151, available from MicrotracMRB Corp).

As a method of detecting resin in the ink, techniques such as Fourier Transform Infrared Spectroscopy (FT-IR), Infrared Spectroscopy (IR), nuclear magnetic resonance (NMR), and pyrolysis gas chromatography-mass spectrometry (GC-MS) can be employed.

The term ‘resin’ refers to a generic name for polymer compounds that solidify, formed by monomers bonded together to create polymers.

Accordingly, the requirement that resin is contained in the present disclosure indicates that, according to the above analytical methods, specific monomer species (compounds) constituting various resins or functional groups characteristic of each resin type can be detected in the liquid composition of the present disclosure, and that this requirement corresponds to the presence of organic solids. The presence of organic solids can be confirmed by the fact that the dried ink forms a mass or film rather than powder.

For such polymer compounds to become solid, a weight average molecular weight of at least 10,000 is required, although this depends on the type of resin.

### Additive

The ink may further optionally include additives such as a surfactant, defoaming agent, preservative and fungicide, corrosion inhibitor, and pH regulator.

The HLB value of a surfactant for use in the present disclosure is to evaluate the hydrophilicity of a compound Griffin advocated and is calculated by the following relationship 1. The HLB value determined by the Griffin method falls within the range of 0 to 20. As the HLB value increases, the hydrophilicity of the compound increases accordingly.

HLB value=20×(mass percent of the hydrophilic group)=20×(sum of the masses of the hydrophilic groups/molecular weight of the surfactant)

The content of the surfactant in the ink is not particularly limited and can be suitably selected according to a particular application. From the viewpoint of enhancing the wettability and discharging stability, and improving the image quality, a content of 0.001 to 5 percent by mass is preferable, and 0.05 to 5 percent by mass is more preferable.

### Defoaming Agent

The defoaming agent has no particular limitation. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### Corrosion Inhibitor

The corrosion inhibitor has no particular limitation.

Specific examples include, but are not limited to, acid sulfites and sodium thiosulfates.

### pH Regulator

The pH regulator is not particularly limited as long as it can control the pH to at least 7. It includes, but is not limited to, amines such as diethanol amine and triethanol amine.

Properties of the ink are not particularly limited and they can be suitably selected according to a particular application. The ink preferably has properties, such as viscosity, surface tension, and pH, in the following ranges.

The ink preferably has a viscosity of from 5 to 30 mPa·s and more preferably from 5 to 25 mPa·s at 25 degrees Celsius to enhance the print density and text quality and achieve good dischargeability. Viscosity can be measured with equipment such as a rotatory viscometer, RE-80L, available from TOKI SANGYO CO., LTD. The measuring conditions are as follows:
Standard cone rotor (1°34′×R24)
Sample liquid amount: 1.2 mL
Rate of rotations: 50 rotations per minute (rpm)
25 degrees Celsius
Measuring time: three minutes.

The surface tension of the ink is preferably at most 35 mN/m and more preferably at most 32 mN/m at 25 degrees Celsius because the ink suitably levels on a recording medium and the ink dries in a short time.

The pH of the ink is preferably from 7 to 12 and more preferably from 8 to 11 to prevent corrosion of the metal material in contact with liquid.

There is no particular limitation on the storage modulus G′ at 25 degrees Celsius, as measured by dynamic viscoelasticity of the dried matter obtained by drying the ink (hereinafter occasionally referred to as ink dried matter). This can be appropriately selected according to the purpose. From the viewpoint of image fastness, it is preferably at most 5.0×10⁹ Pa, and more preferably at most 5.0×10⁸ Pa.

Specific examples of methods of controlling the storage modulus G′ at 25 degrees Celsius of the dried matter obtained by drying the ink include: For example, adjusting factors such as the molecular weight of the resin, the glass transition temperature, the concentration in the resin of monomers having at least three functional groups in which a crosslinked structure is present, or the concentration of hydrogen-bond-forming components such as urethane groups or urea groups.

If the resin in the ink has a large molecular weight, the storage elastic modulus G′ is likely to increase. If the resin in the ink has a small molecular weight, the storage elastic modulus G′ is likely to decrease.

If the resin in the ink has a high glass transition temperature, the storage elastic modulus G′ is likely to increase. If the resin in the ink has a low glass transition temperature, the storage elastic modulus G′ is likely to decrease.

In the present specification, the term “dried material” (ink dried material) obtained by drying the ink refers to the material prepared by: placing 6 mL of the ink in a Teflon dish (diameter: 50 mm); drying it at 40 degrees Celsius and a relative humidity of 60 percent for 12 hours; then further drying it at 150 degrees Celsius and a relative humidity of 60 percent for 12 hours; and finally subjecting it to vacuum drying at 0.5 mmHg and 150 degrees Celsius for 3 hours.

The test piece for use in measuring the dynamic viscoelasticity at 25 degrees Celsius of dried matter obtained by drying the ink mentioned above has a film thickness of from 0.2 to 0.5 mm, a length of 20 mm, and a width of from 4.5 to 5.5 mm. The film thickness is adjustable by adjusting the concentration of ink to be dried.

In the present specification, the value of the storage elastic modulus G′ in measuring the dynamic viscoelasticity at 25 degrees Celsius of dried matter obtained by drying the ink mentioned above is measured with ARES-G2 with a refrigerator, manufactured by TA Instruments. After the test piece is placed in a device at 20 degrees Celsius using a torsion clamp as a jig for fixing the test piece, the test piece is cooled down to −70 degrees Celsius under Autotension of 2 g. Ten minutes after the temperature reaches −70 degrees Celsius, the test piece is measured under the following conditions. The storage elastic modulus at 25 degrees Celsius can be read based on the obtained measurement data.

### Measurement Conditions

Measurement mode: tapping mode
Measuring temperature range: −70 degrees Celsius to 160 degrees Celsius
Rate of temperature rising: 4 degrees Celsius/min
Frequency: 1 Hz
Initial distortion: 0.1 percent
Autotension: 2 g

The organic solvents, resins, surfactants, and other optional components in the ink and processing fluid related to the present disclosure are qualitatively and quantitatively analyzed by Gas Chromatography Mass Spectrometry (GC-MS), for example. One of the measuring devices of GC-MS is GCMS-QP 2020NX, manufactured by Shimadzu Corporation. For each functional group in each component, which functional group modifies a substance can be determined by confirming the peak detected by the measuring method mentioned above.

The moisture contained in the ink and the processing fluid related to the present disclosure is measurable by a known method, such as quantitative analysis of the volatile components by GC-MS or mass variation by thermogravimeter-differential thermal analysis (TG-DTA).

### Printing Medium

The printing (recording) medium for use in printing is not particularly limited.

Specific examples include, but are not limited to, plain paper, glossy paper, special paper, cloth, film, transparent sheets, and printing paper for general purposes.

The recording media are not limited to typical recording media and suitably include building materials such as wall paper, floor material, and tiles, cloth for apparel such as T-shirts, textile, and leather. The configuration of the paths for conveying the printing medium can be changed to accommodate materials such as ceramics, glass, and metal.

### Printed Matter

The ink printed (recorded) matter related to the present disclosure includes the printing medium and an image formed on the printing medium with the ink of the present disclosure.

The ink printed matter is obtained by an inkjet printing (recording) device that executes an inkjet printing (recording) method.

### Water-Soluble Organic Solvent

Among the water-soluble organic solvents, it is preferable to include ethylene glycol, diethylene glycol, triethylene glycol, propylene glycol, and glycerin in order to prevent ink fixation caused by water evaporation.

### Surface Tension

The static surface tension of the ink at 25 degrees Celsius is 26 to 40 mN/m, preferably 29 to 36 mN/m. When the static surface tension is at least 26 mN/m, a meniscus can be easily formed, thereby improving ink discharging stability, and when it is at most 40 mN/m, the image density can be increased.

The static surface tension is measurable at 25 degrees Celsius by the Wilhelmy method.

A commercially available measuring device can be used for measuring the static surface tension, for example, an automatic surface tensiometer (CBVP-Z, manufactured by Kyowa Interface Science Co., Ltd.).

### Cleaning Liquid

### Organic Solvent

The cleaning liquid for use in the present disclosure may contain an organic solvent.

There is no specific limitation on the organic solvent for use in the present disclosure. For example, a water-soluble organic solvent can be used. It includes, but is not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether, ethylene glycol monobenzylether, and trimethyl pentanediol monoisobutyrate; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-buthoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

The proportion of the organic solvent in the ink and cleaning liquid is not particularly limited and can be appropriately selected according to a particular application. In the entire ink, the proportion is preferably from 10 to 80 percent by mass, and more preferably from 20 to 60 percent by mass, to promote quick drying and reduce corrosion of the structural members.

### Water

The proportion of water in the ink and the cleaning liquid is not particularly limited and can be suitably selected according to a particular application. It is preferably from 10 to 90 percent by mass and more preferably from 20 to 80 percent by mass to ensure quick drying and stable ink discharging.

### Other Components

Examples of the other component are surfactants, defoaming agents, preservatives and fungicides, corrosion inhibitors, and pH regulators.

### Surfactant

The HLB value of a surfactant for use in the present disclosure is to evaluate the hydrophilicity of a compound Griffin advocated and is calculated by the following relationship 1. The HLB value determined by the Griffin method falls within the range of 0 to 20. As the HLB value increases, the hydrophilicity of the compound increases accordingly.

HLB value=20×(mass percent of the hydrophilic group)=20×(sum of the masses of the hydrophilic groups/molecular weight of the surfactant)

The proportion of the surfactant in the ink is not particularly limited and it can be suitably selected to suit a particular application. It is preferably from 0.001 to 5 percent by mass and more preferably from 0.05 percent by mass to 5 percent by mass to achieve good wettability and discharging stability and enhance the image quality.

### Defoaming Agent

The defoaming agent has no particular limitation. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### Preservatives and Fungicides

The preservatives and fungicides (preservative and antifungal agents) are not particularly limited. One specific example is 1,2-benzisothiazoline-3-one.

### Corrosion Inhibitor

The corrosion inhibitor has no particular limitation. Specific examples include, but are not limited to, acid sulfites and sodium thiosulfates.

### pH Regulator

The pH regulator is not particularly limited as long as it can control the pH to at least 7. It includes, but is not limited to, amines such as diethanol amine and triethanol amine.

### Contact Angle

The static contact angle of the ink with respect to the water repellent film is at least 66 degrees. When the static contact angle is at least 66 degrees, sufficient water repellency is obtained on the water repellent film, enabling meniscus formation even during long-term use.

The static contact angle of the cleaning liquid with respect to the water repellent film is preferably smaller than that of the ink with respect to the water repellent film from the viewpoint of cleanability, and is preferably at most 65 degrees.

The static contact angle can be measured by, for example, an automatic contact angle measuring device. One example of the automatic contact angle measuring device is Dmo-501 (manufactured by Kyowa Interface Science Co., Ltd.).

The static contact angle can be measured by using the nozzle plate employed in the present disclosure, dispensing 3 μL of ink or cleaning liquid from a syringe onto the surface coated with the water repellent film, and measuring the contact angle after 5 seconds using the above-mentioned device. The static contact angle in the present disclosure means a value at a measurement temperature of 25 degrees Celsius.

### Cleaning Method and Cleaning Device

The image forming apparatus of the present disclosure may include a cleaning method and a cleaning device for cleaning ink remaining on the head with a cleaning liquid.

The cleaning method of the present disclosure is a method of cleaning the nozzle surface of an ink ejection head. The cleaning method of the present disclosure includes applying the cleaning liquid to a wiping member (hereinafter also referred to as cleaning liquid application process), wiping off the nozzle surface (actually water repellent film on the nozzle surface) with the wiping member to which the cleaning liquid is applied (hereinafter also referred to as wiping process), and preferably other optional processes.

In the cleaning method of the present disclosure, the nozzle surface of an ink discharging head is cleaned using a cleaning liquid. This method includes applying the cleaning liquid to the nozzle surface (hereinafter occasionally referred to as the “cleaning liquid applying process”) and wiping the nozzle surface to which the cleaning liquid has been applied with a wiping member (hereinafter occasionally referred to as the “wiping process”), and may further optionally include other processes.

The cleaning device related to the present disclosure is to clean the nozzle surface of an ink discharging head.

This cleaning device includes a device for applying the cleaning liquid to a wiping member (hereinafter occasionally referred to as the “cleaning liquid applying device”) and a device for wiping the nozzle surface with the wiping member to which the cleaning liquid has been applied (hereinafter occasionally referred to as the “wiping device”), and may further optionally include other devices.

The cleaning device of the present disclosure is to clean the nozzle surface of an ink discharging head using a cleaning liquid. This cleaning device includes a device for applying the cleaning liquid to the nozzle surface (hereinafter occasionally referred to as the “cleaning liquid applying device”) and a device for wiping the nozzle surface to which the cleaning liquid has been applied with a wiping member (hereinafter occasionally referred to as the “wiping means”), and may further include other optional devices.

### Cleaning Liquid Applying Process and Cleaning Liquid Applying Device

The wiping member is normally disposed on a pressing member. Such a pressing member is not particularly limited and can be suitably selected according to a particular application as long as it can press the nozzle surface via the wiping member.

Specific examples include, but are not limited to, a pressing roller, a combination of a pressing roller and a pressing belt, a wiper, and a blade. Of these, a pressing roller is preferable.

The head and the wiping member may be brought into contact with each other by moving the head up and down or back and forth if a wipe member is fixed.

The cleaning liquid applying device has no particular limitation and can be suitably selected according to a particular application as long as the cleaning liquid can be applied to the wiping member or the nozzle surface in a constant amount. For example, a nozzle, a spray, a dispenser, and an applicator can be used.

The wiping member has no specific limitation and can be suitably selected according to a particular application. For example, non-woven fabric and cloth can be used. An item rolled up in a roll-like form is preferable. Non-woven fabric having a roll-like form is preferable because it is highly reliable and does not readily produce dust.

It is preferable that the amount of the cleaning liquid to be supplied be controlled depending on recording time. It is more preferable in this case to select the amount from multiple set values. The values are, for example, pressure, number of supplies, and number of nozzles.

It is preferable to control the amount of the supply of the cleaning liquid by a pressure applied to a cleaning liquid applying nozzle as a cleaning liquid applying device. In addition, if the cleaning liquid is applied from multiple cleaning liquid applying nozzles, it is preferable to control the amount of the supply of the cleaning liquid to the wiping member or the nozzle surface by the number of the cleaning liquid applying nozzles. Moreover, it is preferable to control the amount of the supply of the cleaning liquid to the wiping member or the nozzle surface by the number of applying the cleaning liquid from the cleaning liquid applying nozzle.

### Wiping Process and Wiping Device

In the wiping step, the nozzle surface is wiped with the wiping member to which the cleaning liquid has been applied. Alternatively, the nozzle surface to which the cleaning liquid has been applied is wiped with the wiping member. The device suitably executes the wiping step.

The method of wiping the nozzle surface with the wiping member to which the cleaning liquid has been applied has no particular limitation and can be suitably selected according to a particular application. For example, non-woven cloth as the wiping member to which the cleaning liquid has been applied is pressed against the nozzle surface of an ink discharging head.

The method of wiping the nozzle surface to which the cleaning liquid has been applied with the wiping member has no particular limitation and can be suitably selected according to a particular application. For example, the nozzle surface of an ink discharging head to which the cleaning liquid has been applied is wiped by non-woven cloth as the wiping member.

### Other Processes and Other Devices

The other processes and the other devices include, for example, a control process and a control device.

Specific examples of the devices include equipment such as a sequencer and a computer.

FIG. 9 is a schematic diagram illustrating an example of the cleaning device for an ink discharging head relating to the present disclosure. As illustrated in FIG. 9, a cleaning device 300 cleans a nozzle surface 10a on the ink discharging side of a nozzle plate 3 of an ink discharging head.

The cleaning device 300 includes a non-woven fabric 303 as a wiping member, a cleaning liquid applying nozzle 302 as a cleaning liquid applying device, a pressing roller 305 as a pressing member, and a roll-up roller 304 for reeling the non-woven fabric after the wiping.

The cleaning liquid is supplied from a cleaning liquid tank via a cleaning liquid supply tube. When driving a pump disposed in the middle of the cleaning liquid supply tube, the cleaning liquid applying nozzle 302 applies the cleaning liquid to the non-woven fabric 303 as the wiping member in an amount depending on the recording time. The non-woven fabric 303 is rolled up in a roll-like form.

As illustrated in FIG. 9, the non-woven fabric 303 to which the cleaning liquid has been applied is brought into contact with the nozzle surface 301a of the ink nozzle plate 3 under a pressure applied by the pressing roller 305 as the pressing member so that the nozzle surface 10a is cleaned. After the wiping process is complete, the non-woven fabric 303 is rolled up by a roll-up roller 304.

It is possible to provide multiple cleaning liquid applying nozzles 302. A pressure can be applied thereto based on the control by a control device. The applied amount of the cleaning liquid can be adjusted by suitably changing the pressure. In addition, based on the control of the control device, the number of nozzles that applies the cleaning liquid is changed to adjust the applied amount of the cleaning liquid. Furthermore, based on the control of a control device, the amount of cleaning liquid to be applied can be adjusted by changing the number of times the cleaning liquid is applied.

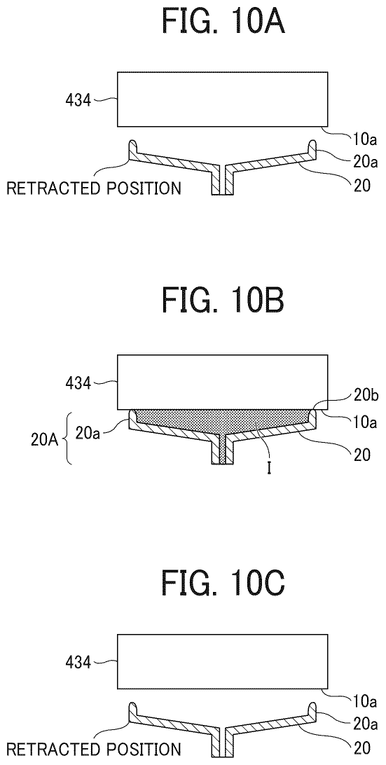

FIG. 10 is a schematic diagram illustrating another example of the cleaning device for the ink discharging head relating to the present disclosure.

FIGS. 10A to 10C illustrate a device for cleaning a nozzle surface 10a by capping the nozzle surface 10a with a cleaning member 20A (FIG. 10B) including a cap 20 filled with a cleaning liquid I and allowing it to stand.

FIG. 10A illustrates a state in which the cap 20 is retracted, and FIG. 10B illustrates a state in which the cap 20 filled with the cleaning liquid I is brought into contact with the head (liquid discharging head) 434.

As illustrated in FIG. 10A, on performing maintenance on the liquid discharging head 434, the cap 20 is moved upward from the retracted position spaced apart from the nozzle surface 10a of the liquid discharging head 434 to perform capping.

Then as illustrated in FIG. 10B, the nozzle surface 10a of the liquid discharging head 434 is cleaned by bringing an end portion 20b of the cap 20 and introducing the cleaning liquid I into the gap between the cap 20 and the nozzle surface 10a and allowing it to stand.

After cleaning the nozzle surface 10a, as illustrated in FIG. 10C, the cap 20 is moved downward away from the nozzle surface 10a, and then the cleaning liquid I inside the cap 20 is discharged.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

### Manufacturing of Nozzle Plate

### Manufacturing of Nozzle Plate A

Next, a nickel nozzle substrate of 34 mm×16 mm with an average thickness of 30 μm was prepared,

The nozzle substrate was fabricated by an electroforming method, and nozzle holes having an average pore diameter of 12 μm were arranged in two rows, each row including 192 nozzle holes at a pitch of 170 μm (150 dpi), which was the shortest distance between the centers of adjacent nozzle holes.

Subsequently, a silicone resin solution (SR2441 RESIN, manufactured by Dow Corning Toray Co., Ltd.) was applied to the ink discharging side surface of the nozzle substrate by a dipping method and dried, thereby forming a preliminary ink repellent film having an average thickness of 100 nm.

During this process, the nozzle orifices were masked with a water soluble resin and the back surface of the nozzle substrate was masked with a tape and the tape was peeled off and removed after forming the preliminary ink repellent film. This material was heated and cured at 150 degrees Celsius for two hours in a nitrogen atmosphere to finally form the ink repellent film. The nozzle plate A was thus manufactured.

### Manufacturing of Nozzle Plate B

A nozzle plate B, having nozzle orifices with an average pore diameter of 18 μm and an ink repellent film with an average thickness of 100 nm, was manufactured using the same nozzle plate and the same method as those employed for Manufacturing Nozzle Plate A.

### Manufacturing of Nozzle Plate C

A nozzle plate C, having nozzle orifices with an average pore diameter of 24 μm and an ink repellent film with an average thickness of 100 nm, was manufactured using the same nozzle plate and the same method as those employed for Manufacturing Nozzle Plate A.

### Manufacturing of Nozzle Plate D

A nozzle plate D, having nozzle orifices with an average pore diameter of 30 μm and an ink repellent film with an average thickness of 100 nm, was manufactured using the same nozzle plate and the same method as those employed for Manufacturing Nozzle Plate A.

### Manufacturing of Nozzle Plate E

A nozzle plate E, having nozzle orifices with an average pore diameter of 36 μm and an ink repellent film with an average thickness of 100 nm, was manufactured using the same nozzle plate and the same method as those employed for Manufacturing Nozzle Plate A.

### Manufacturing of Nozzle Plate F

A fluorinated polyacrylate solution (OPTOOL DSX, manufactured by DAIKIN INDUSTRIES, LTD.) was prepared.

The solution was applied by a dipping method to the ink discharging side surface of a nozzle substrate having the same nozzle orifice diameter of 24 μm as that of Nozzle Plate C. After drying the applied film, an ink repellent layer having an average thickness of 20 nm was formed to manufacture Nozzle Plate F.

During this process, the nozzle orifices were masked with a water-soluble resin and the rear surface of the nozzle substrate was masked with tape, which were removed after the water repellent film was formed.

The film was then heat-treated at 120 degrees Celsius for 1 hour to finally obtain the ink repellent film.

### Manufacturing of Cleaning Liquid and Ink

### Preparation of Pigment Dispersion

Forty parts of titanium oxide (trade name: JR-405, manufactured by Tayca Corporation), 5 parts of a pigment dispersant (TEGO Dispers 651, manufactured by Evonik Industries AG), and 55 parts of water were mixed. The mixture was then dispersed for 5 minutes at 8 m/s using a bead mill (Research Lab, manufactured by Shinmaru Enterprises Co., Ltd.) charged with zirconia beads of 0.3 mm diameter at a filling ratio of 60 percent, thereby obtaining Pigment Dispersion 1.

### Adjustment of Ink

Materials were mixed according to the formulations shown in Table 1 and stirred for one hour, and the resulting mixtures were pressure-filtered through a 1.2 μm cellulose acetate membrane filter to obtain processing fluids. The parts shown in Table 1 represent parts by mass, with the total being 100 parts by mass.

TABLE 1

| | | Ink 1 | Ink 2 | Ink 3 | Ink 4 |
|---|---|---|---|---|---|
| Organic | Glycerin | 10 | 10 | 10 | 10 |
| solvent | 1,2-propane | | | | |
| | diol | | | | |
| | Ethylene glycol | 20 | 20 | 20 | 20 |
| | Diethylene | | | | |
| | glycol | | | | |
| | Triethylene | | | | |
| | glycol | | | | |
| Surfactant | BYK 348 | 0.1 | 0.2 | 0.4 | 1 |
| | Surfynol 465 | | | | |
| Pigment | Pigment | 30 | 30 | 30 | 30 |
| dispersion | dispersion 1 | | | | |
| Resin | TAKELAC | 30 | 30 | 30 | 30 |
| emulsion | W6110 | | | | |
| Deionized | Parts | Balance | Balance | Balance | Balance |
| water | | | | | |

| | | | | |
|---|---|---|---|---|
| Static surface tension | 36 | 32 | 29 | 26 |
| (mN/m) | | | | |

| | | Ink 5 | Ink 6 | Ink 7 |
|---|---|---|---|---|
| Organic | Glycerin | 10 | 10 | |
| solvent | 1,2-propane | | | 20 |
| | diol | | | |
| | Ethylene glycol | 20 | 20 | |
| | Diethylene | | | 5 |
| | glycol | | | |
| | Triethylene | | | 5 |
| | glycol | | | |
| Surfactant | BYK 348 | 1.5 | | 0.2 |
| | Surfynol 465 | | 0.2 | |
| Pigment | Pigment | 30 | 30 | 30 |
| dispersion | dispersion 1 | | | |
| Resin | TAKELAC | 30 | 30 | 30 |
| emulsion | W6110 | | | |
| Deionized | Parts | Balance | Balance | Balance |
| water | | | | |

| | | | |
|---|---|---|---|
| Static surface tension | 24 | 32 | 28 |
| (mN/m) | | | |

### Preparation of Cleaning Liquid

Materials were mixed according to the formulations shown in Table 2 and stirred for one hour, and the resulting mixtures were pressure-filtered through a 1.2 μm cellulose acetate membrane filter to obtain processing fluids. Parts in Table 2 represents parts by mass and the total is 100 parts by mass.

TABLE 2

| | | Cleaning | Cleaning | Cleaning |
|---|---|---|---|---|
| | | liquid 1 | liquid 2 | liquid 3 |
| Organic | 1,3-butane diol | 20 | 20 | 20 |
| solvent | Diethylene glycol | 10 | 10 | 10 |
| | diethyl ether | | | |
| Surfactant | BYK 348 | 0.5 | 1 | |
| | Surfynol 465 | | | 1 |
| Deionized | Parts | Balance | Balance | Balance |
| water | | | | |

| | | | |
|---|---|---|---|
| Total (Percent by mass) | 100 | 100 | 100 |

The materials in the Tables represent the following.
BYK348: silicone-based surfactant (manufactured by BYK-Chemie GmbH)
Surfynol 465, acetylene glycol-based surfactant (manufactured by Nisshin Chemical co., ltd.)
TAKELAC W-6110: urethane resin with a solid content concentration of 30 percent, Tg of −20 degrees Celsius (manufactured by Mitsui Chemicals, Inc.)

### Evaluation

### Surface Tension

The surface tension was measured at 25 degrees Celsius using a fully-automatic surface tensiometer (CBVP-Z, manufactured by Kyowa Interface Science Co., Ltd.).

### Contact Angle

Using an automatic contact angle measuring device (DMo-501, manufactured by Kyowa Interface Science Co., Ltd.), the contact angle was measured 5 seconds after dispensing 3 μL of ink or cleaning liquid from a syringe onto the surface of nozzle plates A to F, which had been coated with the water repellent film. The measurement temperature was 25 degrees Celsius.

### Discharging Stability

A modified inkjet printer (based on GXe5500, manufactured by Ricoh), equipped with nozzle plates A to F, each having two rows of nozzle orifices arranged in 192 nozzles per row, was filled with each ink. The nozzles A to F were then cleaned 10,000 times at 10 minute intervals. Thereafter, ink discharging was carried out, and discharging stability was evaluated based on the following evaluation criterion.

### Evaluation Criterion

For discharging stability, any case in which more than 20 nozzles exhibit irregular discharging or fail to discharge is graded as C (Fail).
S: Irregular discharging or non-discharging not occurred at all
A: At most 5 nozzles exhibit irregular discharging or non-discharging
B: At most 20 nozzles exhibit irregular discharging or non-discharging
C: More than 20 nozzles exhibit irregular discharging or non-discharging

### Recoverability

A modified inkjet printer (based on GXe5500, manufactured by Ricoh), equipped with nozzle plates A to F, each having two rows of nozzle orifices arranged in 192 nozzles per row, was filled with each ink. After filling, the printer was left uncapped for 24 hours under an environment of 32 degrees Celsius and 15 percent relative humidity.

Thereafter, a container filled with the cleaning liquid was attached to the nozzle surface and left for 3 hours, then the container was removed.

Subsequent to a cleaning operation, ink discharging was carried out, and recoverability was evaluated based on the following evaluation criterion.

### Evaluation Criterion

For recoverability, any case in which more than 20 nozzles exhibit irregular discharge or fail to discharge is graded as C (Fail).
S: Irregular discharging or non-discharging not occurred at all
A: At most 5 nozzles exhibit irregular discharging or non-discharging
B: At most 20 nozzles exhibit irregular discharging or non-discharging
C: More than 20 nozzles exhibit irregular discharging or non-discharging

TABLE 3

| | Nozzle plate | | | | |
|---|---|---|---|---|---|
| | | Nozzle | Ink | | |
| | | hole | | Surface | Contact |
| | Type | diameter | Type | tension | angle |
| Example 1 | B | 18 | 3 | 29 | 69 |
| | | | | | degrees |
| Example 2 | C | 24 | 3 | 29 | 69 |
| | | | | | degrees |
| Example 3 | D | 30 | 3 | 29 | 69 |
| | | | | | degrees |
| Example 4 | F | 24 | 3 | 29 | 81 |
| | | | | | degrees |
| Example 5 | C | 24 | 1 | 36 | 72 |
| | | | | | degrees |
| Example 6 | C | 24 | 2 | 32 | 71 |
| | | | | | degrees |
| Example 7 | C | 24 | 4 | 26 | 66 |
| | | | | | degrees |
| Example 8 | C | 24 | 6 | 32 | 72 |
| | | | | | degrees |
| Example 9 | C | 24 | 7 | 28 | 66 |
| | | | | | degrees |
| Example 10 | C | 24 | 3 | 29 | 69 |
| | | | | | degrees |
| Example 11 | C | 24 | 3 | 29 | 69 |
| | | | | | degrees |
| Comparative | A | 12 | 3 | 29 | 69 |
| Example 1 | | | | | degrees |
| Comparative | E | 36 | 3 | 29 | 69 |
| Example 2 | | | | | degrees |
| Comparative | C | 24 | 5 | 24 | 64 |
| Example 3 | | | | | degrees |

| | Cleaning liquid | | Evaluation | |
|---|---|---|---|---|
| | | Contact | Discharging | |
| | Type | angle | stability | Recoverability |
| Example 1 | 1 | 62 | S | A |
| | | degrees | | |
| Example 2 | 1 | 62 | A | A |
| | | degrees | | |
| Example 3 | 1 | 62 | B | S |
| | | degrees | | |
| Example 4 | 1 | 62 | A | B |
| | | degrees | | |
| Example 5 | 1 | 62 | S | S |
| | | degrees | | |
| Example 6 | 1 | 62 | A | S |
| | | degrees | | |
| Example 7 | 1 | 62 | B | S |
| | | degrees | | |
| Example 8 | 1 | 62 | A | A |
| | | degrees | | |
| Example 9 | 1 | 62 | B | S |
| | | degrees | | |
| Example 10 | 2 | 70 | A | B |
| | | degrees | | |
| Example 11 | 3 | 65 | A | B |
| | | degrees | | |
| Comparative | 1 | 62 | S | C |
| Example 1 | | degrees | | |
| Comparative | 1 | 62 | C | S |
| Example 2 | | degrees | | |
| Comparative | 1 | 62 | C | A |
| Example 3 | | degrees | | |

Aspects of the embodiments of the present invention are, for example, as follows:

### Aspect 1

An image forming apparatus includes an ink that contains a pigment, a resin, a water-soluble organic solvent, and water, a cleaning liquid, and a head that includes a nozzle plate including a nozzle substrate with nozzle holes having a diameter of 18 to 30 μm for discharging the ink, and a nozzle surface with water repellent film thereon, wherein the ink has a surface tension of 26 to 40 mN and a contact angle of at least 66 degrees on the water repellent film.

### Aspect 2

The image forming apparatus according to Aspect 1 mentioned above, wherein the cleaning liquid contains a surfactant and water and has a contact angle of at most 65 degrees on the water repellent film.

### Aspect 3

The image forming apparatus according to Aspect 1 or 2 mentioned above, wherein the ink has a surface tension of 29 to 36 mN/m.

### Aspect 4

The image forming apparatus according to any one of Aspects 1 to 3 mentioned above, wherein the ink contains the resin in an amount of at least 6 percent by mass, and the resin has a glass transition temperature of at most 0 degrees Celsius.

### Aspect 5

The image forming apparatus according to any one of Aspects 1 to 4 mentioned above, wherein the water repellent film includes a silicone-based water repellent film, and the cleaning liquid contains a silicone-based surfactant.

### Aspect 6

The image forming apparatus according to any one of Aspects 1 to 5 mentioned above, further includes a wiping device including a wiping member, and a cleaning liquid applying device to impregnate the wiping member with the cleaning liquid, wherein the wiping device wipes the water repellent film with the wiping member to which the cleaning liquid has been applied.

### Aspect 7

The image forming apparatus according to any one of Aspects 1 to 5 mentioned above, further includes a cleaning member including a cap holding the cleaning liquid, wherein the cleaning member is configured to clean the water-repellent film by capping the nozzle surface with the cap holding the cleaning liquid.

### Aspect 8

A set includes an ink containing a pigment, a resin, a water-soluble organic solvent, and water, the cleaning liquid containing a silicone-based surfactant, and water, wherein the set is used in an image forming apparatus that includes a head including a nozzle plate including a nozzle substrate with nozzle holes having a diameter of 18 to 30 μm for discharging the ink, and a nozzle surface with a water repellent film containing a silicone material on the nozzle surface, wherein the cleaning liquid has a static contact angle on the water repellent film of at most 65 degrees, wherein the ink has a surface tension of 26 to 40 mN and a contact angle on the water repellent film of at least 66 degrees.

The above-described embodiments are illustrative and do not limit the present invention. Thus, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. An image forming apparatus comprising:
a pigment;
a resin;
a water-soluble organic solvent; and
water;
including:
a nozzle plate including:
a nozzle substrate having nozzle holes having a diameter of 18 to 30 μm configured to discharge the ink; and
a nozzle surface with water repellent film thereon,
wherein the ink has a surface tension of 26 to 40 mN and a contact angle of at least 66 degrees on the water repellent film.

2. The image forming apparatus according to claim 1,
wherein the cleaning liquid comprises a surfactant and water and has a contact angle of at most 65 degrees on the water repellent film.

3. The image forming apparatus according to claim 1,
wherein the ink has a surface tension of 29 to 36 mN/m.

4. The image forming apparatus according to claim 1,
wherein the ink contains the resin in an amount of at least 6 percent by mass,
wherein the resin has a glass transition temperature of at most 0 degrees Celsius.

5. The image forming apparatus according to claim 1,
wherein the water repellent film comprises a silicone-based water repellent film,
wherein the cleaning liquid comprises a silicone-based surfactant.

6. The image forming apparatus according to claim 1, further comprising:
a wiping device including a wiping member; and
a cleaning liquid applying device to impregnate the wiping member with the cleaning liquid;
wherein the wiping device wipes the water repellent film with the wiping member to which the cleaning liquid has been applied.

7. The image forming apparatus according to claim 1, further comprising:
a cleaning member comprising:
a cap holding the cleaning liquid,
wherein the cleaning member is configured to clean the water repellent film by capping the nozzle surface with the cap holding the cleaning liquid.

8. A set comprising:
an ink comprising:
a pigment;
a resin;
a water-soluble organic solvent; and
water;
a cleaning liquid comprising:
a silicone-based surfactant; and
water,
wherein the set is used in an image forming apparatus that includes a head including:
a nozzle plate including:
a nozzle substrate having nozzle holes having a diameter of 18 to 30 μm configured to discharge the ink; and
a nozzle surface with water repellent film thereon;
wherein the cleaning liquid has a static contact angle on the water repellent film of at most 65 degrees,
wherein the ink has a surface tension of 26 to 40 mN and a contact angle on the water repellent film of at least 66 degrees.
